(19) United States
(12) Patent Application Publication
(10) Pub. No.: US 2023/0354057 A1
(43) Pub. Date: Nov. 2, 2023

(54) BEAM LEVEL COVERAGE AND CAPACITY OPTIMIZATION

(71) Applicant: ZTE CORPORATION, Shenzhen (CN)

(72) Inventors: Jiren HAN, Shenzhen (CN); Yin GAO, Shenzhen (CN); Dapeng LI, Shenzhen (CN)

(73) Assignee: ZTE CORPORATION, Shenzhen (CN)

(21) Appl. No.: 18/348,547

(22) Filed: Jul. 7, 2023

Related U.S. Application Data
(63) Continuation of application No. PCT/CN2021/071532, filed on Jan. 13, 2021.

(51) Int. Cl. H04W 16/28

(52) U.S. Cl. CPC H04W 16/28

(57) ABSTRACT

A wireless communication method for use in a first wireless network node is disclosed. The method comprises transmitting, to a second wireless network node, beam coverage modification information associated with at least one beam of the first wireless network node.

This application is a continuation of PCT/CN2021/071532, filed Jan. 13, 2021, the content of which is incorporated herein by reference in its entirety.

### TECHNICAL FIELD

This document is directed generally to wireless communications.

### BACKGROUND

In new radio (NR), the new architecture and new features of base stations are introduced, wherein the NR base station can be also called gNB. The interface between different gNBs is called Xn, while the interface between a long-term evolution (LTE) base station (e.g. evolved nodeB (eNB)) and gNB is called X2. In addition, the gNB can be split into two parts, i.e. a Central Unit (CU) and a Distributed Unit (DU), and the interface between the gNB-CU and gNB-DU is called F1. In a disaggregate NR base station, there is only one gNB-CU and one gNB-CU is able to control multiple gNB-DUs.

### SUMMARY

Coverage and Capacity Optimization (CCO) is one of the typical operational tasks to optimize the radio access network (RAN). The CCO has been identified as a key use case for Self-Optimization Network (SON) since LTE. The objective of CCO is providing the required capacity in the targeted coverage areas and to minimize the interference and maintain an acceptable quality of service in an autonomous way.

There is a trade-off between coverage and capacity optimization, i.e. capacity enhancements are usually achieved by the expense of service coverage degradation, and vice versa. So, there is a need to balance and manage the trade-off between the two key factors in the network. CCO allows the system to periodically adapt to the changes in traffic (i.e. load and location) and the radio environment.

The present disclosure relates to a wireless communication method for use in a first wireless network node. The method comprises:
transmitting, to a second wireless network node, beam coverage modification information associated with at least one beam of the first wireless network node, and
receiving, from the second wireless network node, a response message.

Various embodiments may preferably implement the following features:

Preferably or in some embodiments, the first wireless network node is one of a next-generation nodeB, gNB, or an evolved nodeB, eNB, and the second wireless network node is one of a gNB or an eNB.

Preferably or in some embodiments, the first wireless network node is one of a central unit of a gNB or a distributed unit of a gNB, and the second wireless network node is another one of the central unit of the gNB or the distributed unit of the gNB.

Preferably or in some embodiments, the beam coverage modification information comprises at least one of:
at least one beam index associated with the at least one beam,
a beam coverage state, indicating a beam coverage configuration of each of the at least one beam,
at least one beam coverage setting, indicating at least one parameter associated with a beam coverage of each of the at least one beam,
a beam deployment status indicator, indicating that a beam coverage state or a beam coverage setting is applied at a next configuration for each of the at least one beam, or
beam replacing information, indicating at least one replacing beam of each of the at least one beam.

Preferably or in some embodiments, the at least one beam index comprises at least one of: a beam index of each of the at least one beam, or at least one beam group identifier associated with the at least one beam, wherein each beam group identifier is associated with multiple beams.

Preferably or in some embodiments, at least one parameter comprises at least one of:
an Azimuth angle,
a tilt angle,
a horizontal beam width, or
a vertical beam width.

Preferably or in some embodiments, the at least one replacing beam is indicated by at least one beam index or by at least one beam group identifier.

The present disclosure relates to a wireless communication method for use in a second wireless network node. The method comprises:
receiving, from a first wireless network node, beam coverage modification information associated with at least one beam of the first wireless network node,
transmitting, to the first wireless network node, a response message, and
adjusting a configuration associated with the at least one beam in the second wireless network node based on the beam coverage modification information.

Various embodiments may preferably implement the following features:

Preferably or in some embodiments, the first wireless network node is one of a next-generation nodeB, gNB, or an evolved nodeB, eNB, and the second wireless network node is one of a gNB or an eNB.

Preferably or in some embodiments, the first wireless network node is one of a central unit of a gNB or a distributed unit of a gNB, and the second wireless network node is another one of the central unit of the gNB or the distributed unit of the gNB.

Preferably or in some embodiments, the beam coverage modification information comprises at least one of:
at least one beam index associated with the at least one beam,
a beam coverage state, indicating a beam coverage configuration of each of the at least one beam,
at least one beam coverage setting, indicating at least one parameter associated with a beam coverage of each of the at least one beam,
a beam deployment status indicator, indicating that a beam coverage state or a beam coverage setting is applied at a next configuration for each of the at least one beam, or
beam replacing information, indicating at least one replacing beam of each of the at least one beam.

Preferably or in some embodiments, the at least one beam index comprises at least one of: a beam index for each of the at least one beam, or at least one beam group identifier associated with the at least one beam,
wherein each of the at least one beam group identifier is associated with multiple beams.

Preferably or in some embodiments, at least one parameter comprises at least one of:
an Azimuth angle,
a tilt angle,
a horizontal beam width, or
a vertical beam width.

Preferably or in some embodiments, the at least one replacing beam is indicated by at least one beam index or by at least one beam group identification.

The present disclosure relates to a first wireless network node. The first wireless network node comprises a communication unit configured to:
transmit, to a second wireless network node, beam coverage modification information associated with at least one beam of the first wireless network node, and
receive, from the second wireless network node, a response message.

Various embodiments may preferably implement the following feature:

Preferably or in some embodiments, the first wireless network node further comprises a processor configured to perform any of the aforementioned wireless communication methods.

The present disclosure relates to a second wireless network node. The second wireless network node comprises:
a communication unit, configured to:
receive, from a first wireless network node, beam coverage modification information associated with at least one beam of the first wireless network node, and
transmit, to the first wireless network node, a response message, and
a processor, configured to adjust a configuration associated with the at least one beam in the second wireless network node based on the beam coverage modification information.

Various embodiments may preferably implement the following feature:

Preferably or in some embodiments, the processor is further configured to perform any of the aforementioned wireless communication methods.

The present disclosure relates to a computer program product comprising a computer-readable program medium code stored thereupon, the code, when executed by a processor, causing the processor to implement a method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF DRAWINGS

FIG. 1 shows an exchange of beam coverage modification information between two NG-RAN nodes according to an embodiment of the present disclosure.

FIG. 2 shows an exchange of beam coverage modification information from gNB-DU to gNB-CU according to an embodiment of the present disclosure.

FIG. 3 shows an exchange of beam coverage modification information from gNB-CU to gNB-DU according to an embodiment of the present disclosure.

FIG. 4 shows an exchange of beam coverage modification information between Master Node and Secondary Node in Dual Connectivity according to an embodiment of the present disclosure.

FIG. 5 shows an example of a schematic diagram of a wireless network node according to an embodiment of the present disclosure.

FIG. 6 shows a flowchart of a method according to an embodiment of the present disclosure.

FIG. 7 shows a flowchart of a method according to an embodiment of the present disclosure.

FIG. 8 shows a flowchart of a method according to an embodiment of the present disclosure.

### DETAILED DESCRIPTION

In the current NR specification, the function of CCO has been introduced, i.e., the cell level coverage modification related information can be exchanged between the gNBs for cell deployment and mobility configuration.

However, as the beam is introduced in the NR as a new key feature, the beam level CCO should also be considered in the NR. To be more specific, the beam level coverage modification related information should be introduced over at least one of interfaces X2, Xn and F1. In fact, the introduction of beam level CCO is beneficial to shape/split/merge the serving beams and optimize the coverage and capacity issues in the NR. In the current NR specification, the beam level CCO procedures and related parameters over different interfaces have not been specified.

From the perspective of interfaces, the beam level CCO related information should be exchanged over different interfaces, such as X2, Xn and F1.

In the present disclosure, the sending node refers to a first (wireless network) node, the receiving node refers to a second (wireless network) node, the message transmitted from the first node to the second node is a first message, and the response message from the second node to the first node is a second message. In detail, the first message includes the beam level coverage modification related information (also called beam coverage modification information herein). The first node may comprise one of: gNB, eNB, gNB-CU and gNB-DU, while the second node may comprise one of: gNB, eNB, gNB-CU and gNB-DU. For example, the first node may be the gNB or eNB and the second node may also be the gNB or eNB. As an alternative, the first node may be one of the gNB-CU and gNB-DU and the second node may be another one of the gNB-CU and gNB-DU.

The beam level coverage modification related information can comprise at least one of: beam index, beam group identifier (ID), beam coverage state, beam coverage settings, beam deployment status indicator, or beam replacing info.

In detail, the beam index indicates (e.g., is associated with, corresponds to) the beam to be modified. Similarly, the beam group ID indicates the group of beams to be modified.

For the beam coverage state, there could be 16 or 32 or 64 values (counting from 0) to represent different beam coverage states. For example, the value “0” indicates that the corresponding beam is inactive, while the other values could indicate the corresponding beam is active and different values separately indicate different beam coverage configurations.

In addition, beam coverage settings indicate at least one parameter that effect (e.g., is associated with) the beam coverage of the corresponding beam. For example, each of the beam coverage settings can comprise at least one of the parameters: azimuth angle, tilt angle, horizontal beam width and vertical beam width.

Note that, the beam coverage state and the beam coverage settings may belong to a single beam (index) or a group (identifier (ID)) of beams.

The beam deployment status indicator is associated with a beam coverage state which is planed (e.g., selected) to be used at the next reconfiguration, e.g., for the beam(s) associated with the beam level coverage modification related information. For example, the beam deployment status indicator may indicate whether the selected beam coverage state will be used at the next configuration, e.g., for the associated beam(s).

The beam replacing info (i.e., beam replacing information) indicates how the original beam(s) will be modified at the next configuration. The beam replacing info may comprise at least one of the beam index and the beam group ID, which respectively indicate a single beam or a group of beams. Based on the beam replacing info, the receiving node could perform (e.g., adjust) mobility configuration to avoid connection or re-establishment failure and to select the target beam(s) for handover (e.g., the handover between the first node and the second node).

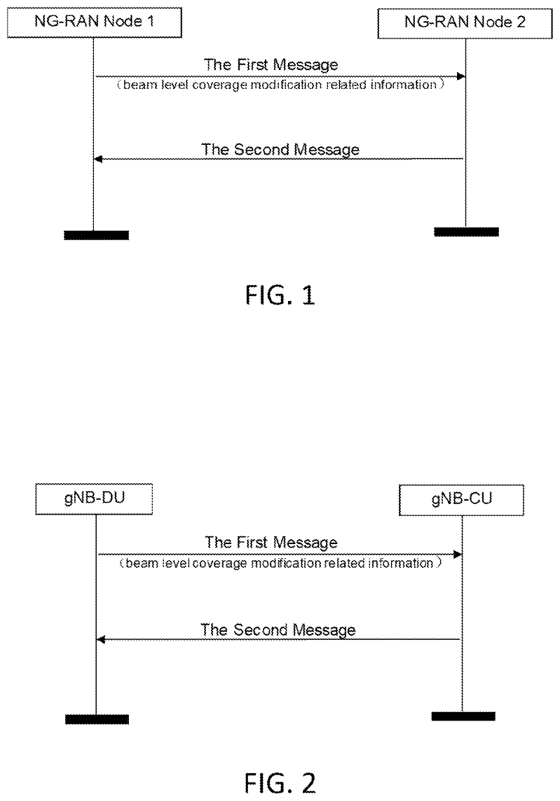

Next, with reference to FIG. 1 an example embodiment of the present disclosure is described. In particular, FIG. 1 shows an exchange of beam coverage modification information between two next generation RAN (NG-RAN) nodes (e.g., gNB(s) and/or NG-eNB(s) and/or EN-gNB(s)).

In this embodiment, both of the nodes are NG-RAN nodes, and the first message is Xn interface signaling. The first message could be but not limited to a NG-RAN node Configuration Update message, while the second message could be but not limited to a NG-RAN node Configuration Update Acknowledge message.

Step 1: The NG-RAN node 1 sends the first message to the NG-RAN node 2, which includes the beam level coverage modification related information. The beam level coverage modification related information can comprise at least one of: beam index, beam group id, beam coverage state, beam coverage settings, beam deployment status indicator, beam replacing info.

Step 2: The NG-RAN node 2 shall send the second message to the NG-RAN node 1. The second message may be referred to as a response message.

In an embodiment, the response message may be an acknowledgement message.

In detail, for beam coverage state, there could be 16 or 32 or 64 values (counting from 0) to represent the different beam coverage states, e.g., the value “0” indicates that the beam is inactive, while the other values could indicate the beam is active and different values indicate different beam coverage configurations.

The beam coverage settings can comprise at least one of the parameters: azimuth angle, tilt angle, horizontal beam width and vertical beam width.

Meanwhile, the beam coverage state and the beam coverage settings could belong to a single beam or a group of beams.

The beam deployment status indicator indicates whether the selected beam coverage state will be used at the next configuration.

The beam replacing info indicates how the original beam(s) will be modified at the next configuration. The beam replacing info can comprise the beam index and beam group ID, which can indicate a single beam or a group of beams, respectively. With the beam replacing info, the NG-RAN node 2 could use it for mobility configuration to avoid connection or re-establishment failure and select the target beam(s) for handover.

To be more specific, for the beam coverage state and beam coverage settings, the NG-RAN node 1 could only send the beam coverage state of a single beam or a group of beams to NG-RAN node 2, or the NG-RAN node 1 only sends the beam coverage settings of a single beam or a group of beams to NG-RAN node 2, or the NG-RAN node 1 sends both the beam coverage state and beam coverage settings of a single beam or a group of beams to NG-RAN node 2.

With this procedure, the NG-RAN node 2 can obtain the beam coverage modification related information in NG-RAN node 1 and accordingly adjust the beam deployment and mobility configuration in NG-RAN node 2.

Next, with reference to FIG. 2 an example embodiment of the present disclosure is described. In particular, FIG. 2 shows an exchange of beam coverage modification information from gNB-DU to gNB-CU.

In this case, the first node is the gNB-DU, the second node is the gNB-CU and the first/second message is F1 interface signaling. The first message could be but not limited to a gNB-DU Configuration Update message, while the second message could be but not limited to a gNB-DU Configuration Update Acknowledge message.

Step 1: The gNB-DU sends the first message to the gNB-CU, which includes beam level coverage modification related information. The beam level coverage modification related information can comprise at least one of: beam index, beam group id, beam coverage state, beam coverage settings, beam deployment status indicator, beam replacing info.

Step 2: The gNB-CU shall send the second message to the gNB-DU. The second message may be referred to as a response message.

In an embodiment, the response message may be an acknowledgement message.

In detail, for beam coverage state, there could be 16 or 32 or 64 values (counting from 0) to represent the different beam coverage states, e.g., the value “0” indicates that the beam is inactive, while the other values could indicate the beam is active and different values indicate different beam coverage configurations.

The beam coverage settings can comprise at least one of the parameters: azimuth angle, tilt angle, horizontal beam width and vertical beam width.

Meanwhile, the beam coverage state and the beam coverage settings could belong to a single beam or a group of beams.

The beam deployment status indicator indicates whether the selected beam coverage state will be used at the next configuration.

The beam replacing info indicates how the original beam(s) will be modified at the next configuration. The beam replacing info can comprise the beam index and beam group ID, which can indicate a single beam or a group of beams, respectively. With the beam replacing info, the gNB-CU could use it for mobility configuration to avoid connection or re-establishment failure and select the target beam(s) for handover.

To be more specific, for the beam coverage state and beam coverage settings, the gNB-DU could only send the beam coverage state of a single beam or a group of beams to gNB-CU, or the gNB-DU only sends the beam coverage settings of a single beam or a group of beams to gNB-CU, or the gNB-DU sends both the beam coverage state and beam coverage settings of a single beam or a group of beams to gNB-CU.

With this procedure, the gNB-CU can obtain the beam coverage modification related information in gNB-DU and adjust the beam deployment and mobility configuration gNB-CU.

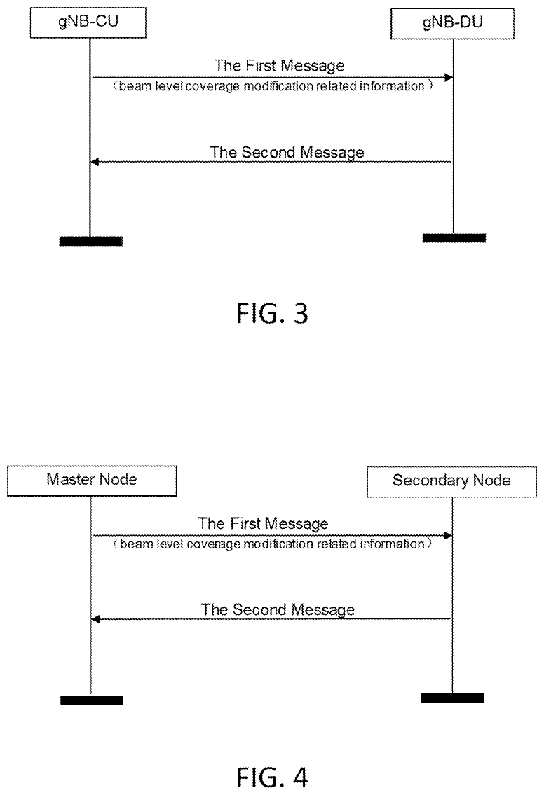

Next, with reference to FIG. 3 an example embodiment of the present disclosure is described. In particular, FIG. 3 shows an exchange of beam coverage modification information from gNB-CU to gNB-DU.

In this case, the first node is the gNB-CU, the second node is the gNB-DU and the first/second message is F1 interface signaling, the first message could be but not limited to a gNB-CU Configuration Update message, while the second message could be but not limited to a gNB-CU Configuration Update Acknowledge message.

Step 1: The gNB-CU sends the first message to the gNB-DU, which includes beam level coverage modification related information. The beam level coverage modification related information can comprise at least one of: beam index, beam group ID, beam coverage state, beam coverage settings, beam deployment status indicator, beam replacing info.

Step 2: The gNB-DU shall send the second message to the gNB-CU. The second message may be referred to as a response message.

In an embodiment, the response message may be an acknowledgement message.

In detail, for beam coverage state, there could be 16 or 32 or 64 values (counting from 0) to represent the different beam coverage states, e.g., the value “0” indicates that the beam is inactive, while the other values could indicate the beam is active and different values indicate different beam coverage configurations.

The beam coverage settings can comprise at least one of the parameters: azimuth angle, tilt angle, horizontal beam width and vertical beam width.

Meanwhile, the beam coverage state and the beam coverage settings could belong to a single beam or a group of beams.

The beam deployment status indicator indicates whether the selected beam coverage state will be used at the next configuration.

The beam replacing info indicates how the original beam(s) will be modified at the next configuration. The beam replacing info can comprise the beam index and beam group ID, which can indicate a single beam or a group of beams, respectively. With the beam replacing info, the gNB-DU could use it for mobility configuration to avoid connection or re-establishment failure and select the target beam(s) for handover.

To be more specific, for the beam coverage state and beam coverage settings, the gNB-CU could only send the beam coverage state of a single beam or a group of beams to gNB-DU, or the gNB-CU only sends the beam coverage settings of a single beam or a group of beams to gNB-DU, or the gNB-CU sends both the beam coverage state and beam coverage settings of a single beam or a group of beams to gNB-DU.

With this procedure, the gNB-DU can obtain the beam coverage modification related information in gNB-CU and adjust the beam deployment and mobility configuration gNB-DU.

Next, with reference to FIG. 4 an example embodiment of the present disclosure is described. In particular, FIG. 4 shows an exchange of beam coverage modification information between Master Node and Secondary Node in Dual Connectivity.

In this case, the first node is a Master Node (MN), the second node is a Secondary Node (SN).

If the MN is eNB and the SN is gNB (e.g., EN-gNB), then the first/second message is EN-DC (E-UTRAN NR dual connectivity) X2 interface signaling, wherein the first message could be but not limited to a EN-DC Configuration Update message, while the second message could be but not limited to a EN-DC Configuration Update Acknowledge message.

If the MN is gNB and the SN is eNB (e.g., NG-eNB) or gNB, then the first/second message is Xn interface signaling, the first message could be but not limited to a NG-RAN Node Configuration Update message, while the second message could be but not limited to a NG-RAN Node Configuration Update Acknowledge message.

Step 1: The MN sends the first message to the SN, which includes beam level coverage modification related information. The beam level coverage modification related information can comprise at least one of: beam index, beam group id, beam coverage state, beam coverage settings, beam deployment status indicator, beam replacing info.

Step 2: The SN shall send the second message to the MN. The second message may be referred to as a response message.

In an embodiment, the response message may be an acknowledgement message.

In detail, for beam coverage state, there could be 16 or 32 or 64 values (counting from 0) to represent the different beam coverage states, e.g., the value “0” indicates that the beam is inactive, while the other value could indicate the beam is active and a different value indicates a different beam coverage configuration.

The beam coverage settings can comprise at least one of the parameters: azimuth angle, tilt angle, horizontal beam width and vertical beam width.

Meanwhile, the beam coverage state and the beam coverage settings could belong to a single beam or a group of beams.

The beam deployment status indicator indicates whether the selected beam coverage state will be used at the next configuration.

The beam replacing info indicates how the original beam(s) will be modified at the next configuration. The beam replacing info can comprise the beam index and beam group ID, which can indicate a single beam or a group of beams, respectively. With the beam replacing info, the SN could use it for mobility configuration to avoid connection or re-establishment failure and select the target beam(s) for handover.

To be more specific, for the beam coverage state and beam coverage settings, the MN could only send the beam coverage state of a single beam or a group of beams to SN, or the MN only sends the beam coverage settings of a single beam or a group of beams to SN, or the MN sends both the beam coverage state and beam coverage settings of a single beam or a group of beams to SN.

With this procedure, the SN can obtain the beam coverage modification related information in MN and adjust the beam deployment and mobility configuration in SN.

In accordance with the foregoing embodiments, for the CCO in the wireless communication network, the beam level coverage modification related information should be exchanged between two different wireless communication nodes.

A first node transmits a first message to the second node, and the beam level coverage modification related information is included in the first message.

The first node can comprise one of: gNB, eNB, gNB-CU and gNB-DU, while the second node can comprise one of: gNB, eNB, gNB-CU and gNB-DU.

The beam level coverage modification related information can comprise at least one of: beam index, beam group id, beam coverage state, beam coverage settings, beam deployment status indicator, beam replacing info.

The beam coverage state could indicate the beam coverage state of a single beam or a group of beams.

The beam coverage settings can comprise at least one of the parameters: azimuth angle, tilt angle, horizontal beam width and vertical beam width. The beam coverage setting could indicate the beam coverage parameters of a single beam or a group of beams.

The beam replacing info can comprise at least one of: the beam index and the beam group ID, which can indicate a single beam and a group of beams, respectively.

The first node could only send the beam coverage state to the second node, or the first node could only send the beam coverage settings to the second node, or the first node could send both of the beam coverage state and beam coverage settings to the second node.

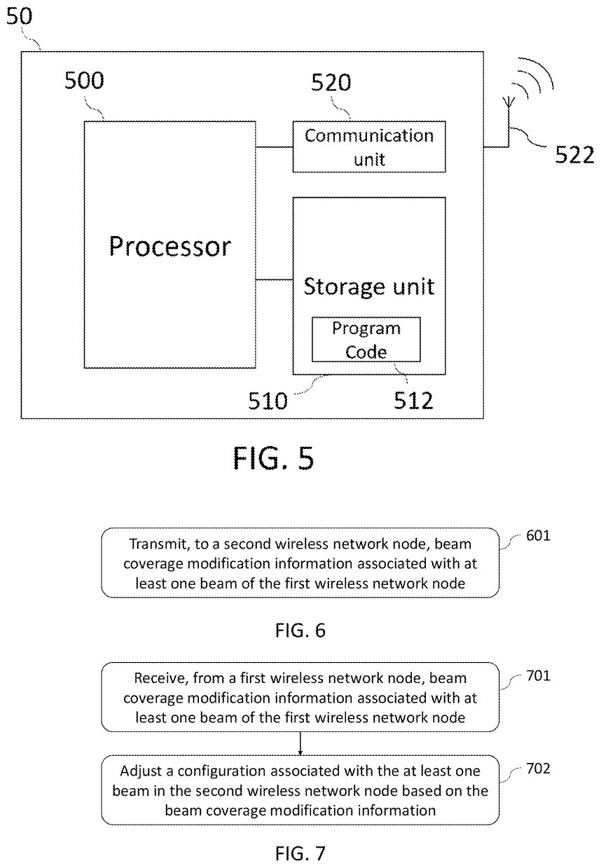

FIG. 5 relates to a schematic diagram of a wireless network node 50 in an embodiment of the present disclosure. The wireless network node 50 may be a communication device, a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB-CU, a gNB-DU, a data network, a core network or a Radio Network Controller (RNC), and is not limited herein. In addition, the wireless network node 50 may comprise (perform) at least one network function such as an access and mobility management function (AMF), a session management function (SMF), a user plane function (UPF), a policy control function (PCF), an application function (AF), an application protocol client function, an application protocol server function, a port management registration and allocation function, a port allocation function, etc. The wireless network node 50 may include a processor 500 such as a microprocessor or ASIC, a storage unit 510 and a communication unit 520. The storage unit 510 may be any data storage device that stores a program code 512, which is accessed and executed by the processor 500. Examples of the storage unit 510 include but are not limited to a SIM, ROM, flash memory, RAM, hard-disk, and optical data storage device. The communication unit 520 may be a transceiver and is used to transmit and receive signals (e.g. messages or packets) according to processing results of the processor 500. In an example, the communication unit 520 transmits and receives the signals via at least one antenna 522 shown in FIG. 5.

In an embodiment, the storage unit 510 and the program code 512 may be omitted. The processor 500 may include a storage unit with stored program code.

The processor 500 may implement any steps described in exemplified embodiments on the wireless network node 50, e.g., via executing the program code 512.

The communication unit 520 may be a transceiver. The communication unit 520 may as an alternative or in addition be combining a transmitting unit and a receiving unit configured to transmit and to receive, respectively, signals to and from a wireless terminal (e.g., a user equipment or another wireless network node).

FIG. 6 shows a flowchart of a method according to an embodiment of the present disclosure. The method shown in FIG. 6 may be used in a first wireless network node (e.g., gNB, eNB, gNB-CU or gNB-DU) and comprises the following step:

Step 601: transmit, to a second wireless network node, beam coverage modification information associated with at least one beam of the first wireless network node.

In FIG. 6, the first wireless network node transmits beam coverage modification information to the second wireless network node (e.g., gNB, eNB, gNB-CU or gNB-DU), to indicate (inform) the second wireless network node beam related information in the first wireless network node. The second wireless network node therefore can accordingly adjust (e.g., optimize, change) its beam deployment and/or configuration, to avoid connection or re-establishment failure and select the target beam(s) for handover between the first wireless network node and the second wireless network node.

In an embodiment, the first wireless network node receives a response message from the second wireless network node. The response message is associated with the beam coverage modification information or is in response to the beam coverage modification information transmission.

In an embodiment, the first wireless network node is one of a gNB or an eNB and the second wireless network node is one of a gNB or an eNB.

In an embodiment, the first wireless network node is one of a gNB-CU or a gNB-DU and the second wireless network node is another one of a gNB-CU or a gNB-DU.

In an embodiment, the beam coverage modification information comprises at least one of:
at least one beam index associated with the at least one beam,
p a beam coverage state, indicating a beam coverage configuration of each of the at least one beam,
at least one beam coverage setting, indicating at least one parameter associated with a beam coverage of each of the at least one beam,
a beam deployment status indicator, indicating that a beam coverage state or a beam coverage setting is applied at a next configuration for each of the at least one beam, or
beam replacing information, indicating at least one replacing beam of each of the at least one beam.

In an embodiment, the at least one beam index comprises at least one of: a beam index of each of the at least one beam, or at least one beam group ID associated with the at least one beam, wherein each beam group ID is associated with multiple beams.

In an embodiment, at least one parameter comprises at least one of:
an Azimuth angle,
a tilt angle,
a horizontal beam width, or
a vertical beam width.

In an embodiment, the at least one replacing beam is indicated by at least one beam index or by at least one beam group ID.

FIG. 7 shows a flowchart of a method according to an embodiment of the present disclosure. The method shown in FIG. 7 may be used in a second wireless network node (e.g., gNB, eNB, gNB-CU or gNB-DU) and comprises the following steps:

Step 701: receive, from a first wireless network node, beam coverage modification information associated with at least one beam of the first wireless network node.

Step 702: adjust a configuration associated with the at least one beam in the second wireless network node based on the beam coverage modification information.

In FIG. 7, the second wireless network receives beam coverage modification information associated with at least one beam of the first wireless network node (e.g., gNB, eNB, gNB-CU or gNB-DU) from the first wireless network node. Based on the beam coverage modification information, the second wireless network node acknowledges beam related information in the first wireless network node and accordingly adjusts (e.g., optimizes, changes) its beam deployment and/or configuration. Thus, the connection or re-establishment failure between the first wireless network and the second wireless network node can be avoided and the target beam(s) for handover between the first wireless network node and the second wireless network node can be appropriately selected (e.g., determined).

In an embodiment, the second wireless network node transmits a response message to the first wireless network node. The response message is associated with the beam coverage modification information or is in response to the beam coverage modification information reception.

In an embodiment, the first wireless network node is one of a gNB or an eNB and the second wireless network node is one of a gNB or an eNB.

In an embodiment, the first wireless network node is one of a gNB-CU or a gNB-DU and the second wireless network node is another one of a gNB-CU or a gNB-DU.

In an embodiment, the beam coverage modification information comprises at least one of:
at least one beam index associated with the at least one beam,
a beam coverage state, indicating a beam coverage configuration of each of the at least one beam,
at least one beam coverage setting, indicating at least one parameter associated with a beam coverage of each of the at least one beam,
a beam deployment status indicator, indicating that a beam coverage state or a beam coverage setting is applied at a next configuration for each of the at least one beam, or
beam replacing information, indicating at least one replacing beam of each of the at least one beam.

In an embodiment, the at least one beam index comprises at least one of: a beam index of each of the at least one beam, or at least one beam group ID associated with the at least one beam, wherein each beam group ID is associated with multiple beams.

In an embodiment, at least one parameter comprises at least one of:
an Azimuth angle,
a tilt angle,
a horizontal beam width, or
a vertical beam width.

In an embodiment, the at least one replacing beam is indicated by at least one beam index or by at least one beam group ID.

In an embodiment, the processes shown in FIGS. 6 and 7 may be combined to be performed by a network system or a wireless network node (i.e., gNB-CU and gNB-DU).

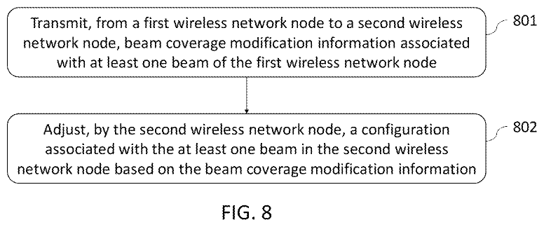

FIG. 8 shows a flowchart of a method according to an embodiment of the present disclosure. The method shown in FIG. 8 may be used in a wireless network system or a wireless network node and comprises the following steps:

Step 801: transmit, from a first wireless network node to a second wireless network node, beam coverage modification information associated with at least one beam of the first wireless network node.

Step 802: adjust, by the second wireless network node, a configuration associated with the at least one beam in the second wireless network node based on the beam coverage modification information.

In FIG. 8, beam coverage modification information associated with at least one beam of the first wireless network node (e.g., gNB, eNB, gNB-CU or gNB-DU) is transmitted from the first wireless network node to the second wireless network node (e.g., gNB, eNB, gNB-CU or gNB-DU). Based on the beam coverage modification information, the second wireless network node acknowledges beam related information in the first wireless network node and accordingly adjust (e.g., optimize) its beam deployment and/or configuration. Thus, the connection or re-establishment failure between the first wireless network and the second wireless network node can be avoided and the target beam(s) for handover between the first wireless network node and the second wireless network node can be appropriately selected (e.g., determined).

In an embodiment, a response message is transmitted from the second wireless network node to the first wireless network node. The response message is associated with the beam coverage modification information or is transmitted in response to the beam coverage modification information transmission.

In an embodiment, the first wireless network node is one of a gNB or an eNB and the second wireless network node is one of a gNB or an eNB.

In an embodiment, the first wireless network node is one of a gNB-CU or a gNB-DU and the second wireless network node is another one of a gNB-CU or a gNB-DU.

In an embodiment, the beam coverage modification information comprises at least one of:
at least one beam index associated with the at least one beam,
a beam coverage state, indicating a beam coverage configuration of each of the at least one beam,
at least one beam coverage setting, indicating at least one parameter associated with a beam coverage of each of the at least one beam,
a beam deployment status indicator, indicating that a beam coverage state or a beam coverage setting is applied at a next configuration for each of the at least one beam, or
beam replacing information, indicating at least one replacing beam of each of the at least one beam.

In an embodiment, the at least one beam index comprises at least one of: a beam index of each of the at least one beam, or at least one beam group ID associated with the at least one beam, wherein each beam group ID is associated with multiple beams.

In an embodiment, at least one parameter comprises at least one of:
an Azimuth angle,
a tilt angle,
a horizontal beam width, or
a vertical beam width.

In an embodiment, the at least one replacing beam is indicated by at least one beam index or by at least one beam group ID.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations but, can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein but, is to be accorded the widest scope consistent with the novel features and principles disclosed herein, as recited in the claims below.

We claim:

1. A wireless communication method for use in a first wireless network node, the method comprising:
transmitting, to a second wireless network node, beam coverage modification information associated with at least one beam of the first wireless network node, and
receiving, from the second wireless network node, a response message.

2. The wireless communication method of claim 1, wherein the first wireless network node is a next-generation nodeB (gNB), and
wherein the second wireless network node is one of a gNB or an evolved nodeB (eNB).

3. The wireless communication method of claim 1, wherein the first wireless network node is an evolved nodeB (eNB), and
wherein the second wireless network node is one of a next-generation nodeB (gNB) or an eNB.

4. The wireless communication method of claim 1, wherein the first wireless network node is a distributed unit of a next-generation nodeB (gNB), and
wherein the second wireless network node is a central unit of the gNB.

5. The wireless communication method of claim 1, wherein the beam coverage modification information comprises:
at least one beam index associated with the at least one beam, and
a beam coverage state, indicating a beam coverage configuration of each of the at least one beam.

6. A wireless communication method for use in a second wireless network node, the method comprising:
receiving, from a first wireless network node, beam coverage modification information associated with at least one beam of the first wireless network node,
transmitting, to the first wireless network node, a response message, and
adjusting a configuration associated with the at least one beam in the second wireless network node based on the beam coverage modification information.

7. The wireless communication method of claim 6, wherein the first wireless network node is one of a next-generation nodeB (gNB), and
wherein the second wireless network node is one of a gNB or an evolved nodeB (eNB).

8. The wireless communication method of claim 6, wherein the first wireless network node is an eNB, and
wherein the second wireless network node is one of a next-generation nodeB (gNB) or an evolved nodeB (eNB).

9. The wireless communication method of claim 6, wherein the first wireless network node is a distributed unit of a next-generation nodeB (gNB), and
wherein the second wireless network node is a central unit of the gNB.

10. The wireless communication method of claim 6, wherein the beam coverage modification information comprises:
at least one beam index associated with the at least one beam, and
a beam coverage state, indicating a beam coverage configuration of each of the at least one beam.

11. A first wireless network node, comprising a processor and a storage unit, wherein the processor is configured to read a program code from the storage unit and to perform:
transmitting, via a transceiver to a second wireless network node, beam coverage modification information associated with at least one beam of the first wireless network node, and
receiving, via the transceiver from the second wireless network node, a response message.

12. The first wireless network node of claim 11, wherein the first wireless network node is a next-generation nodeB (gNB), and
wherein the second wireless network node is one of a gNB or an evolved nodeB (eNB).

13. The first wireless network node of claim 11, wherein the first wireless network node is an evolved nodeB (eNB), and
wherein the second wireless network node is one of a next-generation nodeB (gNB) or an eNB.

14. The first wireless network node of claim 11, wherein the first wireless network node is a distributed unit of a next-generation nodeB (gNB), and
wherein the second wireless network node is a central unit of the gNB.

15. The first wireless network node of claim 11, wherein the beam coverage modification information comprises:
at least one beam index associated with the at least one beam, and
a beam coverage state, indicating a beam coverage configuration of each of the at least one beam.

16. A second wireless network node, comprising a processor and a storage unit, wherein the processor is configured to read a program code from the storage unit and to perform:
receiving, via a transceiver from a first wireless network node, beam coverage modification information associated with at least one beam of the first wireless network node,
transmitting, via the transceiver to the first wireless network node, a response message, and
adjusting a configuration associated with the at least one beam in the second wireless network node based on the beam coverage modification information.

17. The second wireless network node of claim 16, wherein the first wireless network node is one of a next-generation nodeB (gNB), and
wherein the second wireless network node is one of a gNB or an evolved nodeB (eNB).

18. The second wireless network node of claim 16, wherein the first wireless network node is an evolved nodeB (eNB), and
wherein the second wireless network node is one of a next-generation nodeB (gNB) or an eNB.

19. The second wireless network node of claim 16, wherein the first wireless network node is a distributed unit of a next-generation nodeB (gNB), and
wherein the second wireless network node is a central unit of the gNB.

20. The second wireless network node of claim 16, wherein the beam coverage modification information comprises:
at least one beam index associated with the at least one beam, and
a beam coverage state, indicating a beam coverage configuration of each of the at least one beam.
